(19) United States
(12) Patent Application Publication
(10) Pub. No.: US 2018/0257022 A1
(43) Pub. Date: Sep. 13, 2018

(54) ABSORPTION AGENT AND A METHOD FOR SELECTIVELY REMOVING HYDROGEN SULPHIDE

(71) Applicant: BASF SE, Ludwigshafen am Rhein (DE)

(72) Inventors: Thomas INGRAM, Ludwigshafen (DE); Georg SIEDER, Ludwigshafen (DE); Imke PREIBISCH, Hamburg (DE)

(73) Assignee: BASF SE, Ludwigshafen am Rhein (DE)

(21) Appl. No.: 15/760,257

(22) PCT Filed: Sep. 14, 2016
(86) PCT No.: PCT/EP2016/071700

§ 371 Date: Mar. 15, 2018

(30) Foreign Application Priority Data
Sep. 29, 2015 (EP) 15187395.7

(51) Int. Cl. B01D 53/14; C10L 3/10

(52) U.S. Cl. CPC B01D 53/1493; B01D 53/1468; C10L 3/103; B01D 2252/20426; C10L 2290/541; B01D 2252/20405; B01D 2252/2026; B01D 2252/2056; B01D 2252/504; B01D 2252/20484

(57) ABSTRACT

An absorbent for selective removal of hydrogen sulfide from a fluid stream comprising carbon dioxide and hydrogen sulfide, which comprises a) 10% to 70% by weight of at least one sterically hindered secondary amine having at least one ether group and/or at least one hydroxyl group in the molecule; b) at least one nonaqueous solvent having at least two functional groups selected from ether groups and hydroxyl groups in the molecule; and c) optionally a cosolvent; where the hydroxyl group density of the absorbent ρ_{abs} is in the range from 8.5 to 35 mol(OH)/kg. Also described is a process for selectively removing hydrogen sulfide from a fluid stream comprising carbon dioxide and hydrogen sulfide, wherein the fluid stream is contacted with the absorbent. The absorbent features good regeneration capacity and high cyclic acid gas capacity.

The present invention relates to an absorbent and to a process for selectively removing hydrogen sulfide from a fluid stream, especially for selectively removing hydrogen sulfide over carbon dioxide.

The removal of acid gases, for example CO₂, H₂S, SO₂, CS₂, HCN, COS or mercaptans, from fluid streams such as natural gas, refinery gas or synthesis gas is important for various reasons. The content of sulfur compounds in natural gas has to be reduced directly at the natural gas source through suitable treatment measures, since the sulfur compounds form acids having corrosive action in the water frequently entrained by the natural gas. For the transport of the natural gas in a pipeline or further processing in a natural gas liquefaction plant (LNG=liquefied natural gas), given limits for the sulfur-containing impurities therefore have to be observed. In addition, numerous sulfur compounds are malodorous and toxic even at low concentrations.

Carbon dioxide has to be removed from natural gas among other substances, because a high concentration of CO₂ in the case of use as pipeline gas or sales gas reduces the calorific value of the gas. Moreover, CO₂ in conjunction with moisture, which is frequently entrained in the fluid streams, can lead to corrosion in pipes and valves. Too low a concentration of CO₂, in contrast, is likewise undesirable since the calorific value of the gas can be too high as a result. Typically, the CO₂ concentrations for pipeline gas or sales gas are between 1.5% and 3.5% by volume.

Acid gases are removed by using scrubbing operations with aqueous solutions of inorganic or organic bases. When acid gases are dissolved in the absorbent, ions form with the bases. The absorption medium can be regenerated by decompression to a lower pressure and/or by stripping, in which case the ionic species react in reverse to form acid gases and/or are stripped out by means of steam. After the regeneration process, the absorbent can be reused.

A process in which all acid gases, especially CO₂ and H₂S, are very substantially removed is referred to as “total absorption”. In particular cases, in contrast, it may be desirable to preferentially absorb H₂S over CO₂, for example in order to obtain a calorific value-optimized CO₂/H₂S ratio for a downstream Claus plant. In this case, reference is made to “selective scrubbing”. An unfavorable CO₂/H₂S ratio can impair the performance and efficiency of the Claus plant through formation of COS/CS₂ and coking of the Claus catalyst or through too low a calorific value.

Highly sterically hindered secondary amines, such as 2-(2-tert-butylaminoethoxy)ethanol, and tertiary amines, such as methyldiethanolamine (MDEA), exhibit kinetic selectivity for H₂S over CO₂. These amines do not react directly with CO₂; instead, CO₂ is reacted in a slow reaction with the amine and with water to give bicarbonate—in contrast, H₂S reacts immediately in aqueous amine solutions. Such amines are therefore especially suitable for selective removal of H₂S from gas mixtures comprising CO₂ and H₂S.

The selective removal of hydrogen sulfide is frequently employed in the case of fluid streams having low partial acid gas pressures, for example in tail gas, or in the case of acid gas enrichment (AGE), for example for enrichment of H₂S prior to the Claus process.

In the case of natural gas treatment for pipeline gas too, selective removal of H₂S over CO₂ may be desirable. In many cases, the aim in natural gas treatment is simultaneous removal of H₂S and CO₂, wherein given H₂S limits have to be observed but complete removal of CO₂ is unnecessary. The specification typical of pipeline gas requires acid gas removal to about 1.5% to 3.5% by volume of CO₂ and less than 4 ppmv of H₂S. In these cases, maximum H₂S selectivity is undesirable.

DE 31 17 556 A1 describes a process for selectively removing sulfur compounds from CO₂-containing gases by means of an aqueous scrubbing solution comprising tertiary amines and/or sterically hindered primary or secondary amines in the form of diamino ethers or amino alcohols.

US 2015/0027055 A1 describes a process for selectively removing H₂S from a CO₂-containing gas mixture by means of an absorbent comprising sterically hindered, terminally etherified alkanolamines. It was found that the terminal etherification of the alkanolamines and the exclusion of water permits a higher H₂S selectivity.

US 2015/0147254 A1 describes a process for selectively removing hydrogen sulfide over carbon dioxide from a gas mixture by means of an absorbent comprising an amine, water and at least one C₂-C₄-thioalkanol compound. It has been found that the use of thioalkanol compounds allows an elevated H₂S selectivity.

WO 2013/181242 A1 describes an absorbent for selective removal of H₂S over carbon dioxide from a gas mixture by means of an absorbent comprising water, an organic solvent and the reaction product of tert-butylamine and polyethylene glycol within a particular molar mass range.

It was an object of the invention to specify an absorbent and process for selective removal of hydrogen sulfide from a fluid stream comprising carbon dioxide and hydrogen sulfide, wherein the absorbent has good regeneration capacity and high cyclic acid gas capacity.

The object is achieved by an absorbent for selective removal of hydrogen sulfide from a fluid stream comprising carbon dioxide and hydrogen sulfide, which comprises
a) 10% to 70% by weight of at least one sterically hindered secondary amine having at least one ether group and/or at least one hydroxyl group in the molecule;
b) at least one nonaqueous solvent having at least two functional groups selected from ether groups and hydroxyl groups in the molecule; and
c) optionally a cosolvent;
   where the hydroxyl group density of the absorbent ρ_{abs} is in the range from 8.5 to 35 mol(OH)/kg.

The invention also relates to a process for selectively removing hydrogen sulfide from a fluid stream comprising carbon dioxide and hydrogen sulfide, in which the fluid stream is contacted with the absorbent and a laden absorbent and a treated fluid stream are obtained.

Sterically hindered amines exhibit kinetic selectivity for H₂S over CO₂. These amines do not react directly with CO₂; instead, CO₂ is reacted in a slow reaction with the amine and with a proton donor, such as water, to give ionic products.

Hydroxyl groups which are introduced into the absorbent via the sterically hindered amine and/or the solvent are proton donors. It has now been found that controlling the hydroxyl group density of the absorbent allows control over the H₂S selectivity of the absorbent and the regeneration capacity and cyclic acid gas capacity. It is assumed that a low supply of hydroxyl groups in the absorbent makes the CO₂ absorption more difficult. A low hydroxyl group density therefore leads to an increase in H₂S selectivity. It is possible via the hydroxyl group density to establish the desired selectivity of the absorbent for H₂S over CO₂.

The hydroxyl group density of a compound ρ_{compound} is the number of moles of hydroxyl groups per kg of compound and is calculated as

$${ρ}_{compound} = \frac{number of OH groups}{molar mass} \times 1000 ,$$

where the molar mass is entered in g/mol and “number of OH groups” is the number of OH groups in one molecule of the compound. The number of hydroxyl groups in one molecule of water is set to 2, since one water molecule has two hydrogen atoms bonded to one oxygen atom.

To calculate the hydroxyl group density of the absorbent ρ_{abs}, the contributions of the compounds present in the absorbent, i.e. the amines and solvents present, are added up. The contribution of any compound to the hydroxyl group density of the absorbent ρ_{abs} is the product of the hydroxyl group density of the compound ρ_{compound} and the percentage by mass thereof, based on the total weight of the absorbent. In the case of an absorbent consisting of 40% by weight of a compound a), 35% by weight of a compound b) and 25% by weight of a compound c), the hydroxyl group density of the absorbent ρ_{abs} is calculated, for example, as

ρ_{abs}=(ρₐ×0.4)+(ρ_{b}×0.35)+(ρ_{c}×0.25)

According to the invention, the hydroxyl group density of the absorbent is in the range from 8.5 to 35 mol(OH)/kg, preferably in the range from 9.0 to 32 mol(OH)/kg, more preferably in the range from 9.5 to 30 mol(OH)/kg. Relatively high values of ρ_{abs} can result in too low an H₂S selectivity, as a result of which the separation task may not be achieved. In the case of relatively low values of ρ_{abs}, the H₂S selectivity is increased further, but the H₂S loading capacity of the absorbent drops to undesirably low levels.

Preferably, the contribution of the sterically hindered secondary amine a) to ρ_{abs} is in the range from 0 to 6 mol(OH)/kg, more preferably in the range from 1 to 5 mol(OH)/kg and most preferably in the range from 2 to 4 mol(OH)/kg.

Preferably, the contribution of the nonaqueous solvent b) to ρ_{abs} is in the range from 2.5 to 35 mol(OH)/kg, more preferably in the range from 3.5 to 30 mol(OH)/kg and most preferably in the range from 4.5 to 25 mol(OH)/kg.

Preferably, the contribution of the sterically hindered secondary amine a) to ρ_{abs} is in the range from 0 to 6 mol(OH)/kg and the contribution of the nonaqueous solvent b) to ρ_{abs} is in the range from 2.5 to 35 mol(OH)/kg. More preferably, the contribution of the sterically hindered secondary amine a) to ρ_{abs} is in the range from 1 to 5 mol(OH)/kg and the contribution of the nonaqueous solvent b) to ρ_{abs} is in the range from 3.5 to 30 mol(OH)/kg. Most preferably, the contribution of the sterically hindered secondary amine a) to ρ_{abs} is in the range from 2 to 4 mol(OH)/kg and the contribution of the nonaqueous solvent b) to ρ_{abs} is in the range from 4.5 to 25 mol(OH)/kg.

The absorbent comprises 10% to 70% by weight, preferably 15% to 65% by weight, more preferably 20% to 60% by weight, of a sterically hindered secondary amine a) having at least one ether group and/or at least one hydroxyl group in the molecule.

Steric hindrance in the case of secondary amino groups is understood to mean the presence of at least one secondary or tertiary carbon atom directly adjacent to the nitrogen atom of the amino group. The amines a) comprise, as well as sterically hindered secondary amines, also compounds which are referred to in the prior art as highly sterically hindered secondary amines and have a steric parameter (Taft constant) Eₛ of more than 1.75.

A secondary carbon atom is understood to mean a carbon atom which, apart from the bond to the sterically hindered position, has two carbon-carbon bonds. A tertiary carbon atom is understood to mean a carbon atom which, apart from the bond to the sterically hindered position, has three carbon-carbon bonds. A secondary amine is understood to mean a compound having a nitrogen atom substituted by two organic radicals other than hydrogen.

Preferably, the sterically hindered secondary amine a) comprises an isopropylamino group, a tert-butylamino group or a 2,2,6,6-tetramethylpiperidinyl group.

More preferably, the sterically hindered secondary amine a) is selected from 2-(tert-butylamino)ethanol, 2-(isopropylamino)-1-ethanol, 2-(isopropylamino)-1-propanol, 2-(2-tert-butylaminoethoxy)ethanol, 2-(2-isopropylaminoethoxy)ethanol, 2-(2-(2-tert-butylaminoethoxy)ethoxy)ethanol, 2-(2-(2-isopropylaminoethoxy)ethoxy)ethanol, 4-hydroxy-2,2,6,6-tetramethylpiperidine, 4-(3′-hydroxpropoxy)-2,2,6,6-tetramethylpiperidine, 4-(4′-hydroxybutoxy)-2,2,6,6-tetramethylpiperidine, bis(2-(tert-butylamino)ethyl) ether, bis(2-(isopropylamino)ethyl) ether, 2-(2-(2-tert-butylaminoethoxy)ethoxy)ethyl-tert-butylamine, 2-(2-(2-isopropylaminoethoxy)ethoxy)-ethylisopropylamine, 2-(2-(2-(2-tert-butylaminoethoxy)ethoxy)ethoxy)ethyl-tert-butylamine, 2-(2-(2-(2-isopropylaminoethoxy)ethoxy)ethoxy)ethylisopropylamine and 4-(di(2-hydroxyethyl)amino)-2,2,6,6-tetramethylpiperidine.

Most preferably, the sterically hindered secondary amine a) is selected from 2-(2-isopropylaminoethoxy)ethanol (IPAEE), 2-(2-tert-butylaminoethoxy)ethanol (TBAEE), 2-(2-(2-tert-butylaminoethoxy)ethoxy)ethyl-tert-butylamine, 2-(2-(2-isopropylaminoethoxy)ethoxy)ethylisopropylamine, 2-(2-(2-(2-tert-butylaminoethoxy)ethoxy)ethoxy)ethyl-tert-butylamine, and 2-(2-(2-(2-isopropylaminoethoxy)ethoxy)ethoxy)ethylisopropylamine.

Preferably, the absorbent does not comprise any sterically unhindered primary amine or sterically unhindered secondary amine. A sterically unhindered primary amine is understood to mean compounds having primary amino groups to which only hydrogen atoms or primary or secondary carbon atoms are bonded. A sterically unhindered secondary amine is understood to mean compounds having secondary amino groups to which only hydrogen atoms or primary carbon atoms are bonded. Sterically unhindered primary amines or sterically unhindered secondary amines act as strong activators of CO₂ absorption. Their presence in the absorbent can result in loss of the H₂S selectivity of the absorbent.

The absorbent also comprises a nonaqueous solvent b) having at least two functional groups selected from ether groups and hydroxyl groups in the molecule. The nonaqueous solvent b) preferably does not have any thioether or any thiol group. The nonaqueous solvent b) is preferably selected from C₂-C₈ diols, poly(C₂-C₄-alkylene glycols), poly(C₂-C₄-alkylene glycol) monoalkyl ethers and poly(C₂-C₄-alkylene glycol) dialkyl ethers.

More preferably, the nonaqueous solvent b) is selected from ethane-1,2-diol, propane-1,2-diol, propane-1,3-diol, butane-1,4-diol, diethylene glycol, triethylene glycol, tetraethylene glycol, pentaethylene glycol, diethylene glycol monomethyl ether, diethylene glycol monoethyl ether, diethylene glycol monopropyl ether, triethylene glycol monomethyl ether, triethylene glycol monoethyl ether, triethylene glycol monopropyl ether and tetraethylene glycol monomethyl ether.

Most preferably, the nonaqueous solvent b) is selected from propane-1,3-diol, butane-1,4-diol and diethylene glycol and triethylene glycol, especially triethylene glycol.

In a preferred embodiment, the absorbent comprises a sterically hindered secondary amine a) selected from 2-(2-isopropylaminoethoxy)ethanol (IPAEE), 2-(2-tert-butylaminoethoxy)ethanol (TBAEE), 2-(2-(2-tert-butylaminoethoxy)ethoxy)ethyl-tert-butylamine, 2-(2-(2-isopropylaminoethoxy)ethoxy)ethylisopropylamine, 2-(2-(2-(2-tert-butylaminoethoxy)ethoxy)ethoxy)ethyl-tert-butylamine, and 2-(2-(2-(2-isopropylaminoethoxy)ethoxy)ethoxy)ethylisopropylamine, and a nonaqueous solvent b) selected from propane-1,2-diol, propane-1,3-diol, butane-1,4-diol and diethylene glycol and triethylene glycol. In a particularly preferred embodiment, the absorbent comprises TBAEE and triethylene glycol.

The molar ratio of the amine a) to the nonaqueous solvent b) is generally in the range from 0.1 to 1.3, preferably in the range from 0.15 to 1.2, more preferably in the range from 0.2 to 1.1 and most preferably in the range from 0.3 to 1.0.

The absorbent optionally also comprises a cosolvent c). The cosolvent c) can be used in order to achieve a desired ρ_{abs} value. In one embodiment, ρ_{abs} can be lowered by adding a cosolvent c) having a low ρ_{c} (the cosolvent acts as a ρ_{abs} diluent). In that case, the contribution of the cosolvent c) to ρ_{abs} is preferably in the range from 0 to 4 mol(OH)/kg, more preferably in the range from 0 to 2 mol(OH)/kg and most preferably in the range from 0 to 1 mol(OH)/kg.

In a further embodiment, ρ_{abs} can be increased by adding a cosolvent c) having a high ρ_{c} (the cosolvent acts as a ρ_{abs} booster). In that case, the contribution of the cosolvent c) to ρ_{abs} is preferably in the range from 10 to 32.5 mol(OH)/kg, more preferably in the range from 10 to 30 mol(OH)/kg and most preferably in the range from 10 to 25 mol(OH)/kg.

Preferably, the cosolvent c) is selected from water, C₄-C₁₀ alcohols, esters, lactones, amides, lactams, sulfones and cyclic ureas.

More preferably, the cosolvent c) is selected from n-butanol, n-pentanol, n-hexanol, sulfolane, N-methyl-2-pyrrolidone (NMP), dimethylpropyleneurea (DMPU) and γ-butyrolactone. Most preferably, the cosolvent c) is sulfolane.

Water makes a high contribution to the hydroxyl group density of the absorbent. The proportion of water is therefore preferably not more than 30% by weight, more preferably not more than 20% by weight, even more preferably not more than 15% by weight and most preferably not more than 10% by weight.

In a preferred embodiment, the absorbent comprises 20% to 60% by weight of the sterically hindered secondary amine a), 20% to 80% by weight of the nonaqueous solvent b) and 10% to 60% by weight of the cosolvent c), where the cosolvent c) comprises not more than 20% by weight of water, based on the weight of the absorbent.

Preferably, the nonaqueous solvent b) at a temperature of 293.15 K and a pressure of 1.0133·10⁵ Pa has a relative dielectric constant E (also referred to as relative static permittivity) of at least 7, more preferably at least 8.5 and most preferably at least 10. For example, the nonaqueous solvent b) at a temperature of 293.15 K and a pressure of 1.0133·10⁵ Pa has a relative dielectric constant E in the range from 7 to 70.

Preferably, the absorbent comprises the nonaqueous solvent b) and a cosolvent c) in such proportions by mass that a mixture of the nonaqueous solvent b) and a cosolvent c) in a ratio of these proportions by mass at a temperature of 293.15 K and a pressure of 1.0133·10⁵ Pa has a relative dielectric constant E of at least 7, more preferably at least 8.5 and most preferably at least 10. In other words, a mixture of the nonaqueous solvent b) and a cosolvent c) that remains when the amine a) is hypothetically removed from an absorbent of the invention has the specified dielectric constants ε.

For example, the absorbent comprises the nonaqueous solvent b) and a cosolvent c) in such proportions by mass that a mixture of the nonaqueous solvent b) and a cosolvent c) in a ratio of these proportions by mass at a temperature of 293.15 K and a pressure of 1.0133·10⁵ Pa has a relative dielectric constant E in the range from 7 to 70.

The relative dielectric constant E of the compounds present in the absorbent affects the polarity of the absorbent. The absorption of H₂S in the present case is based on ion pair formation between the sterically hindered secondary amine a) and H₂S, the amine a) being present in protonated form and H₂S in deprotonated form. A high polarity of the absorbent is therefore advantageous for the absorption of H₂S.

An example of a suitable source having figures for relative dielectric constants E of relevant compounds is the Handbook of Chemistry and Physics, 92nd Edition (2010-2011), CRC Press. According to the figures therein, for example, ε for n-propanol=20.8, for ethane-1,2-diol=41.4, for propane-1,3-diol=35.1, for triethylene glycol=23.69, for tetraethylene glycol=20.44, for diethylene glycol dimethyl ether=7.23 and for diethylene glycol=31.82.

The absorbent may also comprise additives such as corrosion inhibitors, enzymes, antifoams, etc. In general, the amount of such additives is in the range from about 0.005% to 3% by weight of the absorbent.

The absorbent preferably has an H₂S:CO₂ loading capacity ratio of at least 1.1 and more preferably at least 1.3. The H₂S:CO₂ loading capacity ratio is preferably at most 5.0 and more preferably at most 4.5. Preferably, the absorbent has an H₂S:CO₂ loading capacity ratio in the range from 1.1 to 5.0, more preferably in the range from 1.3 to 4.5.

H₂S:CO₂ loading capacity ratio is understood to mean the quotient of maximum H₂S loading divided by the maximum CO₂ loading under equilibrium conditions in the case of loading of the absorbent with CO₂ and H₂S at 40° C. and ambient pressure (about 1 bar). Suitable test methods are specified in working example 1. The H₂S:CO₂ loading capacity ratio serves as an indication of the expected H₂S selectivity; the higher the H₂S:CO₂ loading capacity ratio, the higher the expected H₂S selectivity.

In a preferred embodiment, the maximum H₂S loading capacity of the absorbent as measured in working example 1 is at least 0.6 mol(H₂S)/mol(amine), more preferably at least 0.7 mol(H₂S)/mol(amine), even more preferably at least 0.75 mol(H₂S)/mol(amine) and most preferably at least 0.8 mol(H₂S)/mol(amine).

The process of the invention is suitable for treatment of all kinds of fluids. Fluids are firstly gases such as natural gas, synthesis gas, coke oven gas, cracking gas, coal gasification gas, cycle gas, landfill gases and combustion gases, and secondly fluids that are essentially immiscible with the absorbent, such as LPG (liquefied petroleum gas) or NGL (natural gas liquids). The process according to the invention is particularly suitable for treatment of hydrocarbonaceous fluid streams. The hydrocarbons present are, for example, aliphatic hydrocarbons such as C₁-C₄ hydrocarbons such as methane, unsaturated hydrocarbons such as ethylene or propylene, or aromatic hydrocarbons such as benzene, toluene or xylene.

The absorbent or process according to the invention is suitable for removal of CO₂ and H₂S. As well as carbon dioxide and hydrogen sulfide, it is possible for other acidic gases to be present in the fluid stream, such as COS and mercaptans. In addition, it is also possible to remove SO₃, SO₂, CS₂ and HCN.

The process according to the invention is suitable for selective removal of hydrogen sulfide over CO₂. In the present context, “selectivity for hydrogen sulfide” is understood to mean the value of the following quotient:

$$\frac{\frac{{y ( {H}_{2} S )}_{feed} - {y ( {H}_{2} S )}_{treat}}{{y ( {H}_{2} S )}_{feed}}}{\frac{{y ( {CO}_{2} )}_{feed} - {y ( {CO}_{2} )}_{treat}}{{y ( {CO}_{2} )}_{feed}}}$$

in which y(H₂S)_{feed} is the molar proportion (mol/mol) of H₂S in the starting fluid, y(H₂S)ₜᵣₑₐₜ is the molar proportion in the treated fluid, y(CO₂)_{feed} is the molar proportion of CO₂ in the starting fluid and y(CO₂)ₜᵣₑₐₜ is the molar proportion of CO₂ in the treated fluid. The selectivity for hydrogen sulfide is preferably at least 4.

In some cases, for example in the case of removal of acid gases from natural gas for use as pipeline gas or sales gas, total absorption of carbon dioxide is undesirable. In one embodiment, the residual carbon dioxide content in the treated fluid stream is at least 0.5% by volume, preferably at least 1.0% by volume and more preferably at least 1.5% by volume.

In preferred embodiments, the fluid stream is a fluid stream comprising hydrocarbons, especially a natural gas stream. More preferably, the fluid stream comprises more than 1.0% by volume of hydrocarbons, even more preferably more than 5.0% by volume of hydrocarbons, most preferably more than 15% by volume of hydrocarbons.

The partial hydrogen sulfide pressure in the fluid stream is typically at least 2.5 mbar. In preferred embodiments, a partial hydrogen sulfide pressure of at least 0.1 bar, especially at least 1 bar, and a partial carbon dioxide pressure of at least 0.2 bar, especially at least 1 bar, is present in the fluid stream. More preferably, there is a partial hydrogen sulfide pressure of at least 0.1 bar and a partial carbon dioxide pressure of at least 1 bar in the fluid stream. Even more preferably, there is a partial hydrogen sulfide pressure of at least 0.5 bar and a partial carbon dioxide pressure of at least 1 bar in the fluid stream. The partial pressures stated are based on the fluid stream on first contact with the absorbent in the absorption step.

In preferred embodiments, a total pressure of at least 3.0 bar, more preferably at least 5.0 bar, even more preferably at least 20 bar, is present in the fluid stream. In preferred embodiments, a total pressure of at most 180 bar is present in the fluid stream. The total pressure is based on the fluid stream on first contact with the absorbent in the absorption step.

In the process according to the invention, the fluid stream is contacted with the absorbent in an absorption step in an absorber, as a result of which carbon dioxide and hydrogen sulfide are at least partly scrubbed out. This gives a CO₂— and H₂S-depleted fluid stream and a CO₂— and H₂S-laden absorbent.

The absorber used is a scrubbing apparatus used in customary gas scrubbing processes. Suitable scrubbing apparatuses are, for example, columns having random packings, having structured packings and having trays, membrane contactors, radial flow scrubbers, jet scrubbers, Venturi scrubbers and rotary spray scrubbers, preferably columns having structured packings, having random packings and having trays, more preferably columns having trays and having random packings. The fluid stream is preferably treated with the absorbent in a column in countercurrent. The fluid is generally fed into the lower region and the absorbent into the upper region of the column. Installed in tray columns are sieve trays, bubble-cap trays or valve trays, over which the liquid flows. Columns having random packings can be filled with different shaped bodies. Heat and mass transfer are improved by the increase in the surface area caused by the shaped bodies, which are usually about 25 to 80 mm in size. Known examples are the Raschig ring (a hollow cylinder), Pall ring, Hiflow ring, Intalox saddle and the like. The random packings can be introduced into the column in an ordered manner, or else randomly (as a bed). Possible materials include glass, ceramic, metal and plastics. Structured packings are a further development of ordered random packings. They have a regular structure. As a result, it is possible in the case of packings to reduce pressure drops in the gas flow. There are various designs of structured packings, for example woven packings or sheet metal packings. Materials used may be metal, plastic, glass and ceramic.

The temperature of the absorbent in the absorption step is generally about 30 to 100° C., and when a column is used is, for example, 30 to 70° C. at the top of the column and 50 to 100° C. at the bottom of the column.

The process according to the invention may comprise one or more, especially two, successive absorption steps. The absorption can be conducted in a plurality of successive component steps, in which case the crude gas comprising the acidic gas constituents is contacted with a substream of the absorbent in each of the component steps. The absorbent with which the crude gas is contacted may already be partly laden with acidic gases, meaning that it may, for example, be an absorbent which has been recycled from a downstream absorption step into the first absorption step, or be partly regenerated absorbent. With regard to the performance of the two-stage absorption, reference is made to publications EP 0 159 495, EP 0 190 434, EP 0 359 991 and WO 00100271.

The person skilled in the art can achieve a high level of hydrogen sulfide removal with a defined selectivity by varying the conditions in the absorption step, such as, more particularly, the absorbent/fluid stream ratio, the column height of the absorber, the type of contact-promoting internals in the absorber, such as random packings, trays or structured packings, and/or the residual loading of the regenerated absorbent.

A low absorbent/fluid stream ratio leads to an elevated selectivity; a higher absorbent/fluid stream ratio leads to a less selective absorption. Since CO₂ is absorbed more slowly than H₂S, more CO₂ is absorbed in a longer residence time than in a shorter residence time. A higher column therefore brings about a less selective absorption. Trays or structured packings with relatively high liquid holdup likewise lead to a less selective absorption. The heating energy introduced in the regeneration can be used to adjust the residual loading of the regenerated absorbent. A lower residual loading of regenerated absorbent leads to improved absorption.

The process preferably comprises a regeneration step in which the CO₂— and H₂S-laden absorbent is regenerated. In the regeneration step, CO₂ and H₂S and optionally further acidic gas constituents are released from the CO₂— and H₂S-laden absorbent to obtain a regenerated absorbent. Preferably, the regenerated absorbent is subsequently recycled into the absorption step. In general, the regeneration step comprises at least one of the measures of heating, decompressing and stripping with an inert fluid.

The regeneration step preferably comprises heating of the absorbent laden with the acidic gas constituents, for example by means of a boiler, natural circulation evaporator, forced circulation evaporator or forced circulation flash evaporator. The absorbed acid gases are stripped out by means of the steam obtained by heating the solution. Rather than steam, it is also possible to use an inert fluid such as nitrogen. The absolute pressure in the desorber is normally 0.1 to 3.5 bar, preferably 1.0 to 2.5 bar. The temperature is normally 50° C. to 170° C., preferably 80° C. to 130° C., the temperature of course being dependent on the pressure.

The regeneration step may alternatively or additionally comprise a decompression. This includes at least one decompression of the laden absorbent from a high pressure as exists in the conduction of the absorption step to a lower pressure. The decompression can be accomplished, for example, by means of a throttle valve and/or a decompression turbine. Regeneration with a decompression stage is described, for example, in publications U.S. Pat. No. 4,537,753 and U.S. Pat. No. 4,553,984.

The acidic gas constituents can be released in the regeneration step, for example, in a decompression column, for example a flash vessel installed vertically or horizontally, or a countercurrent column with internals.

The regeneration column may likewise be a column having random packings, having structured packings or having trays. The regeneration column, at the bottom, has a heater, for example a forced circulation evaporator with circulation pump. At the top, the regeneration column has an outlet for the acid gases released. Entrained absorption medium vapors are condensed in a condenser and recirculated to the column.

It is possible to connect a plurality of decompression columns in series, in which regeneration is effected at different pressures. For example, regeneration can be effected in a preliminary decompression column at a high pressure typically about 1.5 bar above the partial pressure of the acidic gas constituents in the absorption step, and in a main decompression column at a low pressure, for example 1 to 2 bar absolute. Regeneration with two or more decompression stages is described in publications U.S. Pat. No. 4,537,753, U.S. Pat. No. 4,553,984, EP 0 159 495, EP 0 202 600, EP 0 190 434 and EP 0 121 109.

Because of the optimal matching of the compounds present, the inventive absorbent has a high loading capacity with acidic gases which can also be desorbed again easily. In this way, it is possible to significantly reduce energy consumption and solvent circulation in the process according to the invention.

The invention is illustrated in detail by the appended drawing and the examples which follow.

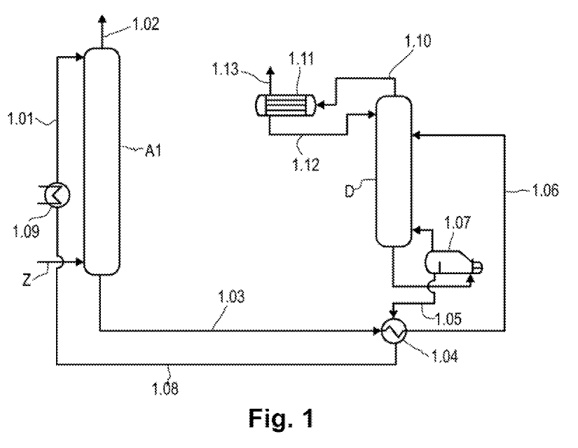

FIG. 1 is a schematic diagram of a plant suitable for performing the process according to the invention.

According to FIG. 1, via the inlet Z, a suitably pretreated gas comprising hydrogen sulfide and carbon dioxide is contacted in countercurrent, in an absorber A1, with regenerated absorbent which is fed in via the absorbent line 1.01. The absorbent removes hydrogen sulfide and carbon dioxide from the gas by absorption; this affords a hydrogen sulfide- and carbon dioxide-depleted clean gas via the offgas line 1.02.

Via the absorbent line 1.03, the heat exchanger 1.04 in which the CO₂— and H₂S-laden absorbent is heated up with the heat from the regenerated absorbent conducted through the absorbent line 1.05, and the absorbent line 1.06, the CO₂— and H₂S-laden absorbent is fed to the desorption column D and regenerated.

Between the absorber A1 and heat exchanger 1.04, one or more flash vessels may be provided (not shown in FIG. 1), in which the CO₂— and H₂S-laden absorbent is decompressed to, for example, 3 to 15 bar.

From the lower part of the desorption column D, the absorbent is conducted into the boiler 1.07, where it is heated. The steam that arises is recycled into the desorption column D, while the regenerated absorbent is fed back to the absorber A1 via the absorbent line 1.05, the heat exchanger 1.04 in which the regenerated absorbent heats up the CO₂— and H₂S-laden absorbent and at the same time cools down itself, the absorbent line 1.08, the cooler 1.09 and the absorbent line 1.01. Instead of the boiler shown, it is also possible to use other heat exchanger types for energy introduction, such as a natural circulation evaporator, forced circulation evaporator or forced circulation flash evaporator. In the case of these evaporator types, a mixed-phase stream of regenerated absorbent and steam is returned to the bottom of the desorption column D, where the phase separation between the vapor and the absorbent takes place. The regenerated absorbent to the heat exchanger 1.04 is either drawn off from the circulation stream from the bottom of the desorption column D to the evaporator or conducted via a separate line directly from the bottom of the desorption column D to the heat exchanger 1.04.

The CO₂— and H₂S-containing gas released in the desorption column D leaves the desorption column D via the offgas line 1.10. It is conducted into a condenser with integrated phase separation 1.11, where it is separated from entrained absorbent vapor. In this and all the other plants suitable for performance of the process according to the invention, condensation and phase separation may also be present separately from one another. Subsequently, the condensate is conducted through the absorbent line 1.12 into the upper region of the desorption column D, and a CO₂— and H₂S-containing gas is discharged via the gas line 1.13.

### EXAMPLES

The following table shows the hydroxyl group density p of selected compounds:

| | Number | Molar | ρ |
|---|---|---|---|
| | of OH | mass | [mol(OH)/ |
| Compound | groups | [g/mol] | kg] |
| Methanol | 1 | 32.04 | 31.21 |
| n-Butanol | 1 | 74.12 | 13.49 |
| n-Pentanol | 1 | 88.15 | 11.34 |
| n-Hexanol | 1 | 102.18 | 9.79 |
| Ethane-1,2-diol (ethylene glycol, EG) | 2 | 62.07 | 32.22 |
| Propane-1,3-diol | 2 | 76.09 | 26.28 |
| Butane-1,4-diol | 2 | 90.12 | 22.19 |
| Diethylene glycol (DEG) | 2 | 106.12 | 18.85 |
| Triethylene glycol (TEG) | 2 | 150.18 | 13.32 |
| Tetraethylene glycol | 2 | 194.23 | 10.30 |
| Pentaethylene glycol | 2 | 238.30 | 8.39 |
| Diethylene glycol monomethyl ether | 1 | 120.15 | 8.32 |
| Diethylene glycol monoethyl ether | 1 | 134.18 | 7.45 |
| Diethylene glycol monopropyl ether | 1 | 148.20 | 6.75 |
| Triethylene glycol monomethyl ether | 1 | 164.20 | 6.09 |
| Triethylene glycol monoethyl ether | 1 | 178.20 | 5.61 |
| Triethylene glycol monopropyl ether | 1 | 192.25 | 5.20 |
| Tetraethylene glycol monomethyl ether | 1 | 208.26 | 4.80 |
| Polyethylene glycol dimethyl ether | 0 | 250.00* | 0.00 |
| (PEGDME) | | | |
| Dimethylethanolamine (DMAE) | 1 | 89.14 | 11.22 |
| Methyldiethanolamine (MDEA) | 2 | 119.16 | 16.78 |
| 2-(Isopropylamino)ethanol (IPAE) | 1 | 103.16 | 9.69 |
| 2-Isopropylamino-1-propanol (IPAP) | 1 | 117.19 | 8.53 |
| 2-(2-Isopropylaminoethoxy)ethanol | 1 | 147.00 | 6.80 |
| (IPAEE) | | | |
| tert-Butylaminoethanol (TBAE) | 1 | 117.19 | 8.53 |
| 2-(2-tert-Butylaminoethoxy)ethanol | 1 | 161.00 | 6.21 |
| (TBAEE) | | | |
| Dibutylaminoethanol (DBAE) | 1 | 173.3 | 5.77 |
| Triethanolamine (TEA) | 3 | 149.2 | 20.11 |
| Sulfolane | 0 | 120.17 | 0.00 |
| Water | 2 | 18.02 | 110.99 |

*mean molar mass

### Example 1

A thermostated jacketed glass cylinder was initially charged with about 250 mL of unladen absorbent according to table 1. In order to prevent any loss of absorbent during the experiment, a glass condenser which was operated at 5° C. was connected at the top of the glass cylinder. To determine the absorption capacity, at ambient pressure and 40° C., 8 L (STP)/h of H₂S or CO₂ were passed through the absorption liquid via a frit. After the experiment had run for 4 h, the maximum loading had been attained. This was verified by sampling after 1, 2 and 3 h. The loading of CO₂ or H₂S was determined as follows:

The determination of H₂S was effected by titration with silver nitrate solution. For this purpose, the sample to be analyzed was weighed into an aqueous solution together with about 2% by weight of sodium acetate and about 3% by weight of ammonia. Subsequently, the H₂S content was determined by a potentiometric turning point titration by means of silver nitrate solution. At the turning point, H₂S is fully bound as Ag₂S. The CO₂ content was determined as total inorganic carbon (TOC-V Series Shimadzu).

The loading of CO₂ and H₂S was identical within the measurement accuracy after an experiment duration of 3 h and 4 h. The H₂S:CO₂ loading capacity ratio was calculated as the quotient of the H₂S loading divided by the CO₂ loading.

The laden solution was stripped by heating the apparatus to 80° C., introducing the laden absorbent and stripping it by means of a nitrogen stream (8 L (STP)/h) at ambient pressure. After 30 min, a sample was taken and the CO₂ or H₂S loading of the absorbent was determined as described above.

The results are shown in table 1.

TABLE 1

| | | ρ_{abs} | CO₂ loading | | H₂S loading | | H₂S:CO₂ |
|---|---|---|---|---|---|---|---|
| Absorbent | | [mol(OH)/ | [mol(CO₂)/mol(amine)] | | [mol(H₂S)/mol(amine)] | | loading |
| # | Composition | kg] | after loading | after stripping | after loading | after stripping | capacity ratio |
| 1-1* | 40% by wt. of MDEA + | 73.31 | 0.683 | 0.019 | 0.744 | 0.062 | 1.09 |
| | 60% by wt. of water | | | | | | |
| 1-2* | 30% by wt. of MDEA + | 27.59 | 0.275 | 0.015 | 0.605 | 0.046 | 2.2 |
| | 70% by wt. of EG | | | | | | |
| 1-3* | 30% by wt. of MDEA + | 14.36 | 0.078 | 0.001 | 0.468 | 0.003 | 6 |
| | 70% by wt. of TEG | | | | | | |
| 1-4* | 30% by wt. of MDEA + | 5.04 | 0.058 | 0.001 | 0.323 | 0.001 | 5.6 |
| | 70% by wt. of | | | | | | |
| | sulfolane | | | | | | |
| 1-5* | 30% by wt. of TBAEE + | 79.55 | 0.972 | 0.236 | 0.922 | 0.250 | 0.95 |
| | 70% by wt. of water | | | | | | |
| 1-6 | 30% by wt. of TBAEE + | 24.42 | 0.795 | 0.007 | 1.101 | 0.154 | 1.38 |
| | 70% by wt. of EG | | | | | | |
| 1-7 | 30% by wt. of TBAEE + | 11.19 | 0.280 | 0.001 | 1.192 | 0.006 | 4.25 |
| | 70% by wt. of TEG | | | | | | |
| 1-8* | 30% by wt. of TBAEE + | 1.86 | 0.060 | 0.00 | 0.837 | 0.002 | 13.95 |
| | 70% by wt. of | | | | | | |
| | sulfolane | | | | | | |
| 1-9 | 30% by wt. of TBAEE + | 11.5 | 0.467 | 0.004 | 0.907 | 0.010 | 1.94 |
| | 30% by wt. of EG + | | | | | | |
| | 40% by wt. of | | | | | | |
| | sulfolane | | | | | | |
| 1-10* | 30% by wt. of TBAEE + | 5.8 | 0.132 | 0.001 | 0.780 | 0.005 | 5.9 |
| | 30% by wt. of TEG + | | | | | | |
| | 40% by wt. of | | | | | | |
| | sulfolane | | | | | | |
| 1-11 | 30% by wt. of TBAE + | 25.1 | 0.828 | 0.019 | —** | —** | —** |
| | 70% by wt. of EG | | | | | | |
| 1-12 | 30% by wt. of TBAE + | 11.9 | 0.369 | 0.002 | —** | —** | —** |
| | 70% by wt. of TEG | | | | | | |
| 1-13 | 30% by wt. of IPAEE + | 24.6 | 0.707 | 0.034 | —** | —** | —** |
| | 70% by wt. of EG | | | | | | |
| 1-14 | 30% by wt. of IPAE + | 25.5 | 0.636 | 0.027 | —** | —** | —** |
| | 70% by wt. of EG | | | | | | |
| 1-15* | 30% by wt. of DBAE + | 24.3 | 0.340 | 0.002 | —** | —** | —** |
| | 70% by wt. of EG | | | | | | |
| 1-16* | 30% by wt. of TEA + | 28.6 | 0.137 | 0.002 | —** | —** | —** |
| | 70% by wt. of EG | | | | | | |
| 1-17* | 30% by wt. of MDEA + | 5.04 | 0.029 | 0.001 | 0.218 | 0.001 | 7.5 |
| | 70% by wt. of | | | | | | |
| | PEGDME | | | | | | |
| 1-18* | 30% by wt. of TBAEE + | 1.86 | 0.030 | 0.001 | 0.396 | 0.001 | 13.2 |
| | 70% by wt. of | | | | | | |
| | PEGDME | | | | | | |

*comparative example
**not determined

Examples 1-1 to 1-4 and 1-5 to 1-8 show that the H₂S:CO₂ loading capacity ratio increases with decreasing hydroxyl group density ρ_{abs}. A decreasing hydroxyl group density ρ_{abs} likewise results in improved regeneration, apparent from low residual H₂S and CO₂ loadings after stripping. Too low a hydroxyl group density ρ_{abs} results in reduced CO₂ and H₂S loading capacities, as apparent from examples 1-8, 1-9, 1-10, 1-17 and 1-18.

It is clear from the comparison of examples 1-6 and 1-7 with comparative examples 1-2 and 1-3 that the sterically hindered secondary amine TBAEE, as compared with the tertiary amine MDEA, allows elevated CO₂ and H₂S loading combined with comparable H₂S:CO₂ loading capacity ratio and similarly good regeneration.

1. An absorbent for selective removal of hydrogen sulfide over carbon dioxide from a fluid stream, which comprises:
a) 10% to 70% by weight of at least one sterically hindered secondary amine having at least one ether group and at least one hydroxyl group in the molecule;
b) at least one nonaqueous solvent having at least two functional groups selected from the group consisting of ether groups and hydroxyl groups in the molecule; and
c) optionally a cosolvent;
where a hydroxyl group density of the absorbent ρ_{abs} is in a range from 8.5 to 35 mol(OH)/kg.

2. The absorbent according to claim 1, wherein a contribution ρₐ of the sterically hindered secondary amine a) to ρ_{abs} is in a range from 0 to 6 mol(OH)/kg and a contribution ρ_{b} of the nonaqueous solvent b) to ρ_{abs} is in a range from 2.5 to 35 mol(OH)/kg.

3. The absorbent according to claim 1, wherein the sterically hindered secondary amine a) comprises an isopropylamino group, a tert-butylamino group or a 2,2,6,6-tetramethylpiperidinyl group.

4. The absorbent according to claim 1, wherein the sterically hindered secondary amine a) is selected from the group consisting of 2-(2-tert-butylaminoethoxy)ethanol, 2-(2-isopropylaminoethoxy)ethanol, 2-(2-(2-tert-butylaminoethoxy)ethoxy)ethanol, 2-(2-(2-isopropylaminoethoxy)ethoxy)ethanol, 4-(3′-hydroxypropoxy)-2,2,6,6-tetramethylpiperidine and 4-(4′-hydroxybutoxy)-2,2,6,6-tetramethylpiperidine.

5. The absorbent according to claim 1, wherein the nonaqueous solvent b) at a temperature of 293.15 K and a pressure of 1.0133·10⁵ Pa has a relative dielectric constant c of at least 7.

6. The absorbent according to claim 1, wherein the absorbent comprises the nonaqueous solvent b) and a cosolvent c) in such proportions by mass that a mixture of the nonaqueous solvent b) and a cosolvent c) in a ratio of these proportions by mass at a temperature of 293.15 K and a pressure of 1.0133·10⁵ Pa has a relative dielectric constant 8 of at least 7.

7. The absorbent according to claim 1, wherein the absorbent does not comprise any sterically unhindered primary or secondary amines.

8. The absorbent according to claim 1, wherein the nonaqueous solvent b) is selected from the group consisting of C₂-C₈ diols, poly(C₂-C₄-alkylene glycols), poly(C₂-C₄-alkylene glycol) monoalkyl ethers and poly(C₂-C₄-alkylene glycol) dialkyl ethers.

9. The absorbent according to claim 8, wherein the nonaqueous solvent b) is selected from the group consisting of ethane-1,2-diol, propane-1,2-diol, propane-1,3-diol, butane-1,4-diol, diethylene glycol, triethylene glycol, tetraethylene glycol, pentaethylene glycol, diethylene glycol monomethyl ether, diethylene glycol monoethyl ether, diethylene glycol monopropyl ether, triethylene glycol monomethyl ether, triethylene glycol monoethyl ether, triethylene glycol monopropyl ether and tetraethylene glycol monomethyl ether.

10. The absorbent according to claim 1, wherein the cosolvent c) is present, and is selected from the group consisting of water, C₄-C₁₀ alcohols, esters, lactones, amides, lactams, sulfones and cyclic ureas.

11. The absorbent according to claim 10, wherein the cosolvent c) is selected from the group consisting of n-butanol, n-pentanol, n-hexanol, sulfolane, N-methyl-2-pyrrolidone, dimethylpropyleneurea and γ-butyrolactone.

12. The absorbent according to claim 1, wherein the absorbent comprises 20% to 60% by weight of the sterically hindered secondary amine a), 20% to 80% by weight of the nonaqueous solvent b) and 10% to 60% by weight of the cosolvent c), where the cosolvent c) comprises not more than 20% by weight, based on the weight of the absorbent, of water.

13. A process for selectively removing hydrogen sulfide over carbon dioxide from a fluid stream, comprising contacting the fluid stream with the absorbent according to claim 1 to obtain a laden absorbent and a treated fluid stream.

14. The process according to claim 13, further comprising regenerating the laden absorbent by at least one of the measures of heating, decompressing and stripping with an inert fluid.
